(19) United States
(12) Patent Application Publication
(10) Pub. No.: US 2026/0272214 A1
(43) Pub. Date: Sep. 17, 2026

(54) SYSTEM, METHOD, AND APPARATUS FOR A BEVERAGE PRODUCING AND DISPENSING APPARATUS INCLUDING AUTOMATIC SCHEDULING

(71) Applicant: BUNN COMMERCIAL LP, Springfield, IL (US)

(72) Inventors: Jason M. BANNING, Springfield, IL (US); Jonathan CLARK, Springfield, IL (US); Joel MORTON, Springfield, IL (US)

(21) Appl. No.: 19/565,120

(22) Filed: Mar. 12, 2026

Related U.S. Application Data
(60) Provisional application No. 63/770,580, filed on Mar. 12, 2025.

(51) Int. Cl. A47J 31/52; A47J 31/00; G06N 20/00

(52) U.S. Cl. CPC A47J 31/525; A47J 31/007; G06N 20/00

(57) ABSTRACT

A brewer includes a brewing assembly that dispenses a brewed beverage into one or more reservoirs, an intelligent scheduler, and a refill controller. The intelligent scheduler uses one or more machine learning models to generate a hold volume schedule based on historical brew event data, the hold volume schedule specifying a target volume of brewed beverage to maintain in the reservoirs across multiple time intervals. The machine learning models also predict beverage waste and customer wait time, with model weights tunable based on user-adjustable goal criteria that set relative priorities between minimizing waste and reducing wait times. The refill controller initiates brewing based on the hold volume schedule to fill the reservoirs to the target volume. The intelligent scheduler periodically updates the hold volume schedule using updated historical brew event data. The system is also applicable to general beverage producing and dispensing systems.

### PRIORITY CLAIM AND CROSS REFERENCE

This application claims the benefit of priority under 35 U.S.C. § 119(e) to U.S. Provisional Application No. 63/770,580, filed Mar. 12, 2025, including Appendix A and Appendix B filed therewith which is owned in the entirety by the Applicant of the present application, the entirety of which is incorporated by reference. This application also incorporates herein by reference in their entirety the subject matter of the following applications and patents which are owned in the entirety by the Applicant of the present application, including International Application No. PCT/US 2025/024135, filed Apr. 10, 2025, which claims priority to U.S. Provisional Application No. 63/632,404, filed Apr. 10, 2024, and U.S. application Ser. No. 18/433,944, filed Feb. 6, 2024, which claims priority to U.S. Pat. No. 11,889,943, issued Feb. 6, 2024, International Application No. PCT/US 2019/028367, filed Apr. 19, 2019, which claims priority to U.S. Provisional Application No. 62/660,085, filed Apr. 19, 2018, and U.S. Pat. No. 8,950,318 , issued Feb. 10, 2015.

### BACKGROUND

The present disclosure includes a beverage making and dispensing apparatus, method and system for controllably preparing batches of beverage from beverage making substance such as fresh ground coffee beans. The present disclosure overcome numerous problems associated with prior systems that produce fresh coffee from fresh ground beans. One of the problems that is overcome is the provision of a brewer that can accommodate several reservoirs to hold separate batches of fresh brewed coffee and a selectively controlled dispensing of coffee from those reservoirs on demand. The prior art also has issues with the space management of multiple reservoirs associated with a single brewer often requiring movement of various reservoirs to and from a brewing dispense point.

The present disclosure also includes solutions to problems associated with inconsistent distribution of total dissolved solids within a brewed beverage. The present disclosure provides a solution to this problem that also can be used to solve a problem associated with cleaning of solids and fines which can be left behind within and on the internal surfaces of a reservoir. Another issue associated with the present disclosure is the reduction of heat loss in the brewed beverage being dispensed from the reservoirs when multiple reservoirs are contained in the overall apparatus. A structure is provided in the present disclosure that helps reduce the heat loss and possible overspray of coffee being dispensed during the brewing process. The present disclosure also provides systems and methods for scheduling the dispensing into reservoirs and the operation of the brewer. This system operation as well as a controllable dashboard that provides a virtual relationship to the physical reservoir is used to help manage the control of the brewer and the dispensing into the various reservoirs.

The present disclosure also provides information about the use of proximity sensing to help enhance brewer readiness and provide attractive indicia when a potential customer is detected.

The present disclosure also relates to a simulation system that overcomes problems with apparatus operators capturing data and understanding product availability, apparatus maintenance, and waste reduction among other factors impacting brewer operations and productivity.

Also provided is an on demand dispensing option to provide single cup dispensing on demand without having to have a full reservoir.

In addition, a variable pour handle/faucet system is provided to provide a digitally controlled faucet dispensing system which is analogous to a physical dispensing faucet and provides dispensing of variable volumes controlled by the user.

This background information is provided to provide some information believed by the applicant to be of possible relevance to the present disclosure. No admission is intended, nor should such admission be inferred or construed, that any of the preceding information constitutes prior art against the present invention. Other aims, objects, advantages and features of the invention will become more apparent upon reading of the following non restrictive description of specific embodiments thereof, given by way of example only with reference to the accompanying drawings.

### BRIEF DESCRIPTION OF THE DRAWINGS

The present disclosure will be described hereafter with reference to the attached drawings which are given as a non-limiting example only, in which:

FIG. 1 is a perspective view of a brewing apparatus as set forth in the disclosure, the brewing apparatus includes a brew engine that receives fresh coffee beans from hoppers positioned proximate thereto for delivery of beans to a grinder operatively associated with the brew engine, a user interface is provided to control the brew engine and dispensing of beans from the hopper, a reservoir housing is associated with the apparatus to receive fresh brewed coffee from the brew engine and for controllable dispensing therefrom at a dispensing point located on the housing of the apparatus;

FIG. 2 is an enlarged partial fragmentary view of an interior perspective of the reservoir housing shown in FIG. 1 showing the relationship between multiple reservoirs and a docking assembly associated with the housing, associated controllable pumps and corresponding plumbing are provided below the reservoirs to transport brewed beverage from the reservoirs to the dispensing point upon control at the user interface;

FIG. 3 is an enlarged perspective view of a docking tray showing a docking port which cooperatively engages a corresponding reservoir port positioned on the bottom area of the reservoir;

FIG. 4 is an enlarged view of a reservoir removed from the reservoir housing showing the body of the reservoir and including a reservoir port on the bottom portion of the reservoir for communication and engagement with the docking port of the docking tray as shown in FIGS. 2 and 3, an asymmetrically located handle is provided which is also shown in FIG. 2, to facilitate better gripping and leverage when inserting and removing reservoirs from a compartment defined within the reservoir housing;

FIG. 5 is an enlarged cross sectional view of the reservoir port engaging the docking port in the docking tray to show the alignment and engagement between these structures facilitating reducing or preventing drip or leakage when engaging the components of the reservoir port with the docking port, the docking port providing a protruding portion 55 to disengage a corresponding normally biased closed member within the reservoir port so as to open a path from the internal cavity of the reservoir through the reservoir port and into the docking port which also communicates with the pumps and plumbing as previously described;

FIG. 6 is a bottom view of the reservoir as shown in FIG. 4 illustrating the displaceable member described with regard to FIG. 5 and also illustrating conductive contact points on the bottom of the reservoir for mating with corresponding conductive points in the docking tray as shown in FIG. 3, engagement of the reservoir conductive contact points with the docking tray conductive contact points providing a communication path for communicating information about the characteristics of the reservoir as well as the contents of the reservoir including positioning of the reservoir in the docking tray, the life or degree freshness of the beverage in the reservoir as determined by the time the beverage has been in the reservoir, the level of the contents of the reservoir, and other characteristics;

FIG. 7 shows a side, cross sectional, elevational view of a reservoir engaged in the docking tray as shown in FIG. 2 further illustrating components associated with the pumps and plumbing as described in FIG. 2 to facilitate delivery or injection of air through the plumbing and into the reservoir, the air injection port being used to facilitate agitation of brewed beverage within the reservoir to promote mixing of the contents of the reservoir to help generally distribute dissolved solids within the liquid beverage and enhance entrainment of solids within the liquid portion, and to also facilitate agitation of liquid and cleaning products within the reservoir during a clean-in-place cleaning cycle (“CIP cycle”) to promote enhancing distribution of the cleaning products over the surfaces and structures of the reservoir and systems communicating therewith and distribution of rising products or water at the end of the CIP cycle;

FIG. 8 is an enlarged perspective view of the plumbing and pump portion as described in FIG. 2 showing an air agitation port connected to the dispense line extending downwardly from the reservoir engaged with the dispense line via the docking port and reservoir port, air agitation being provided as a result of an air pump controllably operated by a controller associated with the apparatus to facilitate controlled movement of air through the air passage into the dispensing line with the air following the path of least resistance upwardly through the dispensing line into the reservoir, agitation of the air in the liquid beverage causing mixing of the dissolved solids with the beverage as described;

FIG. 9 is an enlarged perspective view of a series of level sensors contained within the server and positioned along the server wall as also shown in FIG. 7 to facilitate controllable monitoring of the condition of coffee or other beverages within the server, also showing in FIG. 9 and internal perspective of the reservoir port showing the displaceable portion retained within the port;

FIG. 10 is an enlarged perspective view of the reservoirs retained in the reservoir housing showing a swing arm apparatus extending downwardly from an upper portion of the reservoir for facilitating controlled positive location of brewer for dispensing brewed beverage from the brewer into a top opening in the corresponding reservoirs;

FIG. 11 is top perspective view taken above the area defining a top portion of the reservoir housing cavity showing brewer dispense lines extending downwardly through holes therein for communication of coffee for dispensing into each of the three reservoirs as shown in the illustrations;

FIG. 12 is a perspective view below the panel as shown in FIG. 11 in which the dispensing lines extend downwardly through the plane and into the assembly wherein the end ports are retained on the assembly and can be controllably directed by the hinged movement of the swing arm assembly, also showing magnetic contacts, one on the plane and one on the assembly for retained engagement of the arm in an up position to move the end ports out of the way while moving reservoirs into and out of the reservoir housing cavity;

FIG. 13 shows a perspective view in which the swing arm is positioned downwardly directing the dispensing lines downwardly over corresponding reservoirs (not shown in FIG. 13) such as those aligned in FIG. 2, with secondary magnetic couplings on a spaced apart location of the assembly from the first magnetic couplings, engaging corresponding couplings on the plane to retain the assembly in a downward position for dispensing, the magnetic couplings and/or sensors providing positive detection of the position of the assembly to controllably operate or block operation of the dispensing of beverage from the brewer to the reservoirs depending on the location of the end ports;

FIG. 14 shows a simplified block diagram of at least one embodiment of a system with one or more brewers having auto-scheduling functionality to facilitate enhanced coffee system management by providing tools to try to reduce coffee, cleaner, and water waste and help optimize labor efforts to elevate profitability of the related coffee delivery program;

FIG. 15 shows a simplified block diagram of at least one embodiment of a brewer in the system of FIG. 14;

FIG. 16 is a simplified block diagram of at least one embodiment of an environment of the brewer during operation;

FIG. 17 is an example schedule for at least one embodiment of the brewer in the system of FIG. 14; and

FIG. 18 is a simplified block diagram of at least one embodiment of an environment of the simulation compute device during operation.

The exemplification set out herein illustrates embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure. The disclosure is not limited in its application to the details of structure, function, construction, or the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of various phrases and terms is meant to encompass the items or functions identified and equivalents thereof as well as additional items or functions. Unless limited otherwise, various phrases, terms, and variations thereof herein are used broadly and encompass all variations of such phrases and terms. Furthermore, and as described in subsequent paragraphs, the specific configurations illustrated in the drawings are intended to exemplify embodiments of the disclosure. However, other alternative structures, functions, and configurations are possible which are considered to be within the teachings of the present disclosure. Furthermore, unless otherwise indicated, the term “or” is to be considered inclusive.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

Terms including beverage, brewed, brewing, brewing substance, brewed liquid, and brewed beverage as may be used herein are intended to be broadly defined as including, but not limited to, the brewing of coffee, tea and any other beverages. This broad interpretation is also intended to include, but is not limited to any process of dispensing, infusing, steeping, reconstituting, diluting, dissolving, saturating or passing a liquid through or otherwise mixing or combining a beverage substance with a liquid such as water without limitation to the temperature of such liquid unless specified. This broad interpretation is also intended to including, but is not limited to beverage substances such as ground coffee, tea, liquid beverage concentrate, powdered beverage concentrate, flaked, granular, freeze dried or other forms of materials including liquid, gel, crystal or other forms of beverage or food materials to obtain a desired beverage or other food product.

The specification uses the term brewer, brewing, brewing assembly, and brewed beverage as terms of convenience for describing one type of beverage production that is generally well known to the public, namely, coffee brewing. However, it is envisioned that the present application is also applicable to other forms of beverage production comprising a beverage producing and dispensing system, for producing beverage, having a beverage producing assembly to dispense a produced beverage. As will be described, the production of beverage using a variety of means, in any number of forms or embodiments is incorporated in the present disclosure. All of the afore mentioned forms of beverage production, including, but not limited to brewing is intended to be encompassed in the present disclosure.

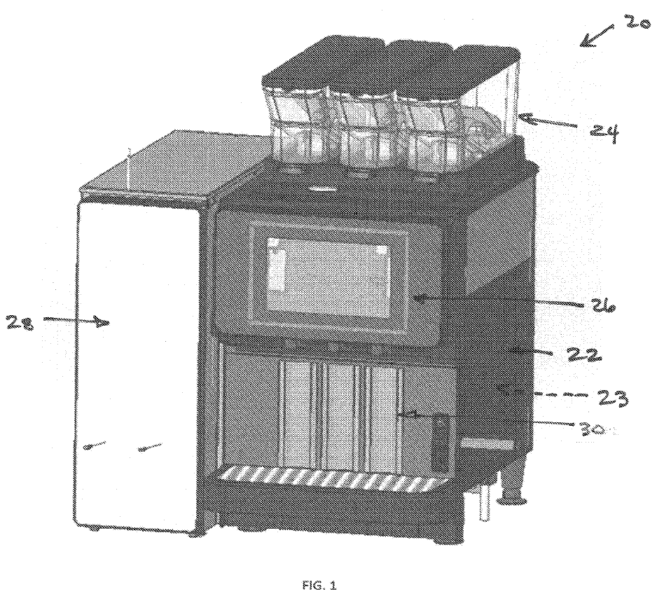

As shown in FIG. 1, a beverage making and dispensing apparatus 20 includes a housing 22 which contains a brewer assembly 23 (not specifically shown herein) such as the device disclosed and shown in co-pending U.S. patent application No. Ser. No. 17/048,882 filed Oct. 19, 2020 and claiming priority to the applications indicated above. The beverage making and dispensing apparatus, method and system controllably prepare batches of beverage from beverage making substance such as fresh ground coffee beans. The brewer assembly 23 or “brew engine” is used to produce controlled, pre-determined quantities of freshly brewed beverage from freshly ground coffee beans which are retained in one or more hoppers 24 positioned proximate to the brew engine 23 for grinding and delivery to the brew engine 23. A user interface 26 is provided on an exterior portion of the housing 22 to allow a user to control the operation of the brewer. The user interface includes a controller for selectively operatively controlling the apparatus to make and dispense beverages. A reservoir housing 28 is provided next to and controllably associated with the overall apparatus. Coffee is brewed from the fresh ground beans in the brew engine 23 and transferred to reservoirs retained within the reservoir housing 28. Coffee can then be controllably dispensed on demand for dispending at a dispensing point 30 located generally proximate to the user interface 26.

The beverage making engine 23 associated with the housing 20, and controllably operated by the controller. The brew engine 23 controllably receiving a predetermined quantity of beverage making substance and beverage making liquid for producing a predetermined beverage. At least a plurality of reservoirs 40, 41 individually operatively associated with the apparatus and retained in the housing. Each reservoir controllably operatively communicating with the beverage making engine 23 to controllably, individually receive separate batches of beverage produced by the beverage making engine. Beverage selectively, controllably dispensable from each reservoir on demand by selective controllable operation of a dispensing valve communicating with each reservoir.

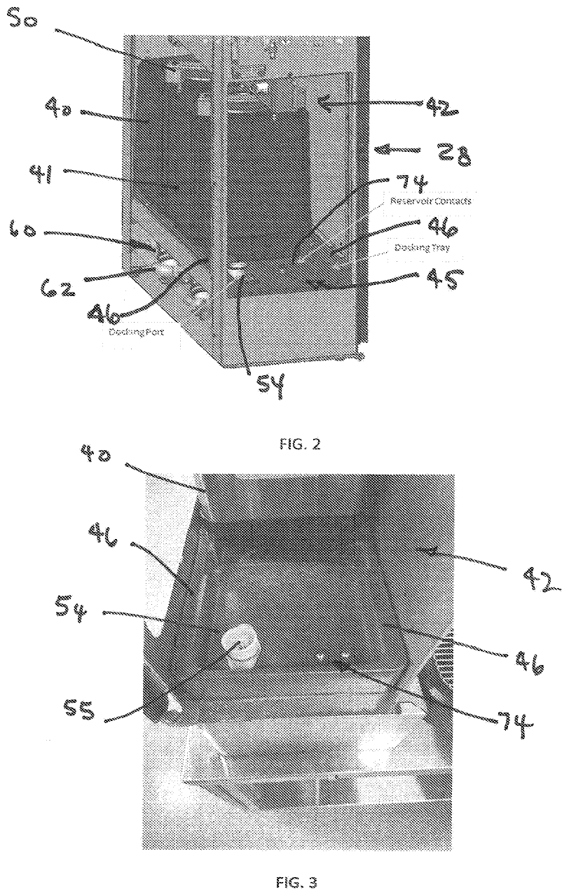

As shown in FIGS. 2-6 a series of reservoirs 40, 41 are shown in a cavity 42 of the reservoir housing 28. A docking tray 45 is provided in a lower section of the housing 28 for receiving reservoirs thereon. The docking tray 45 includes a pair of spaced apart rails 46, 46 that allows the correspondingly designed reservoir 40 to slide there along when positioning it in the cavity 42. An asymmetrically positioned handle 50 is positioned on an upper portion of the reservoir 40 offset therefrom to allow the oriented positioning of the reservoirs within the cavity 42. The asymmetric design allows for better gripping and/or leverage when installing and removing reservoirs from the cavity 42.

A lower portion of the reservoir includes a reservoir port 52 and a corresponding docking port 54 is provided on the docking tray 45. As shown in FIG. 5, the docking ports 52, 54 engage one another to allow the normally biased closed reservoir port 52 having a displaceable closure 56 to be biased upwardly by a protruding portion 55 to allow the passage of beverage retained in the reservoir 40 from the reservoir and through the docking port 54. Coffee is retained in this passage until it is controllably pumped by the pumps 60 and corresponding plumbing 62 to move the coffee from the reservoir 40 to the dispensing point 30.

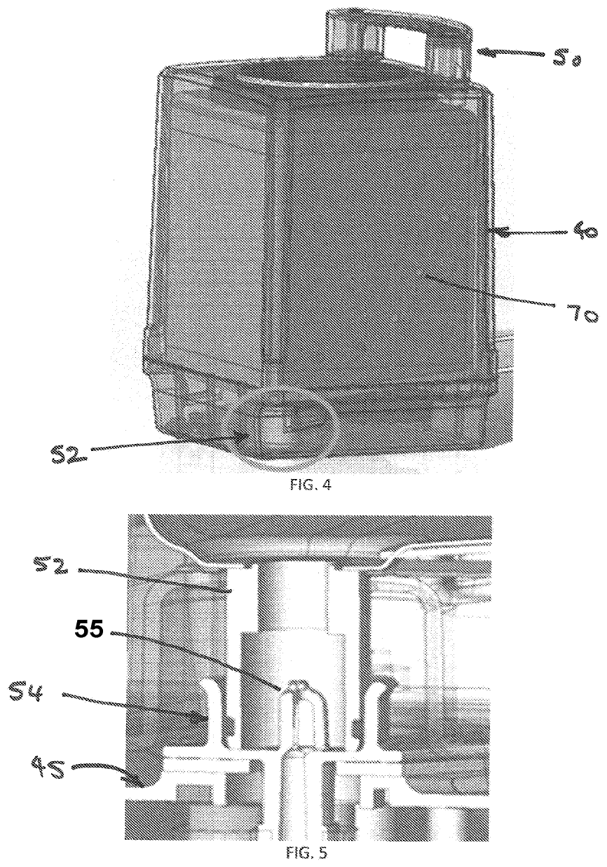

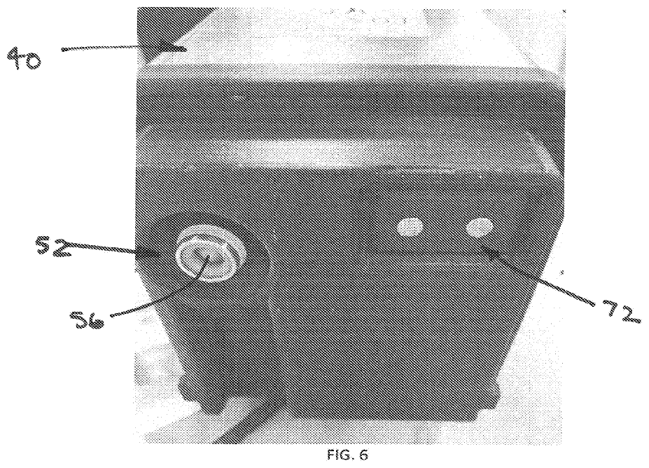

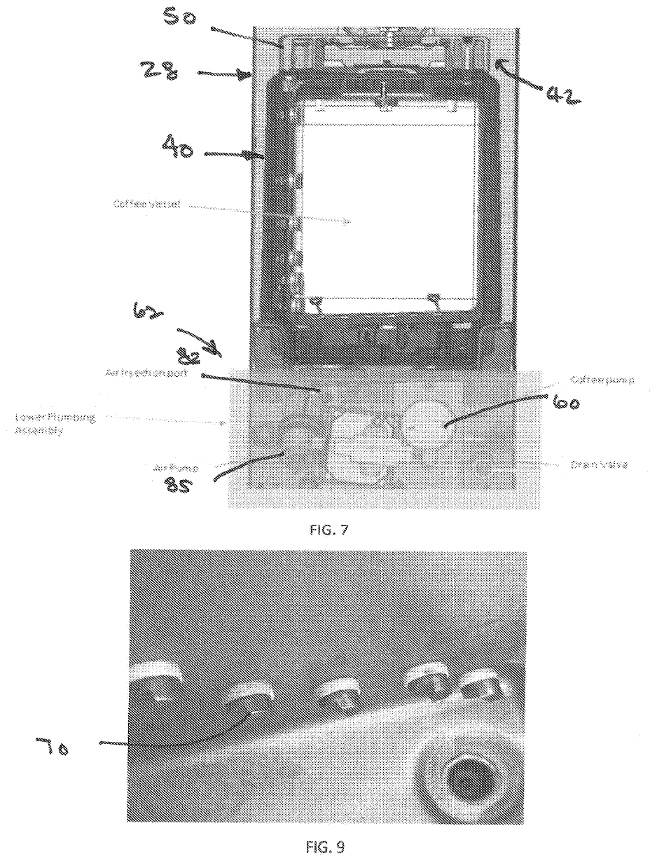

A series of sensors and contacts are provided on the reservoir, first a series of level sensors 70 are attached to an interior surface of the reservoir as shown in FIGS. 7 and 9. These contact points are also shown in FIG. 4. In addition, reservoir contacts 72 are provided on the bottom of the reservoir (see FIG. 6) which engage corresponding tray contacts 74 on the tray. Engagement of the reservoir and tray contacts 72, 74 provides a conductive path to communicate information about the characteristics of beverage retained in the reservoir.

An air injection assembly is shown in FIGS. 7 and 8 in which an air injection line 86 is connected to and communicates with a dispensing line 82. The dispensing line 82 directly communicates with the contents of the reservoir through the reservoir port 52 and the docking port 54. The dispense line 82 as shown in FIG. 8 generally is directed downwardly to an additional feed line 84 that is pumped to controllably deliver beverage to the dispense point 30. A controller controls all of the systems in the apparatus 20 by way of appropriate software coding. An air pump 85 is attached to an airline 86 which communicates with the dispensing line 82. When the air pump 85 is controllably operated air is fed through the air line 86 into the dispense line 82. Following the path of least resistance upwardly into the dispense line 82 and the reservoir, the air agitation moves liquid each reservoir to help to agitate and mix the contents of the reservoir. Air agitation is beneficial to beverages retained in the reservoirs to provide movement of dissolved solids and, perhaps, fines within the liquid to prevent precipitation and settling of these components out of solution. The air injection line 86 is also used to facilitate agitation of liquid and cleaning products within the reservoir to enhance thorough cleaning during a clean-in-place cleaning cycle (“CIP cycle”) by moving cleaning products used in the CIP cycle throughout and over the interior surfaces of the reservoir. A normally closed check valve 88 is provide on the air line 86 to prevent the backflow of liquid into the air line 86 when the pump 85 is not operated.

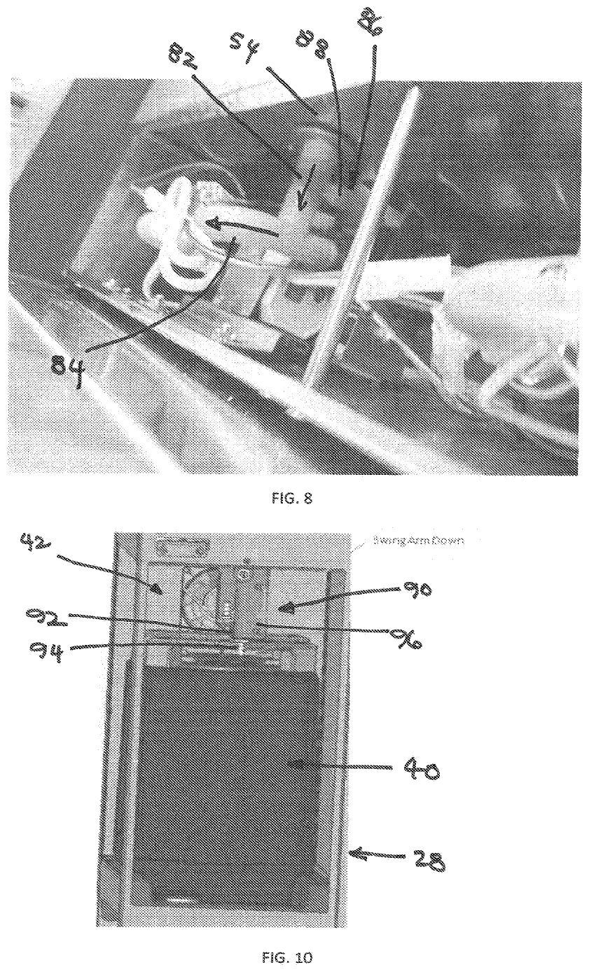

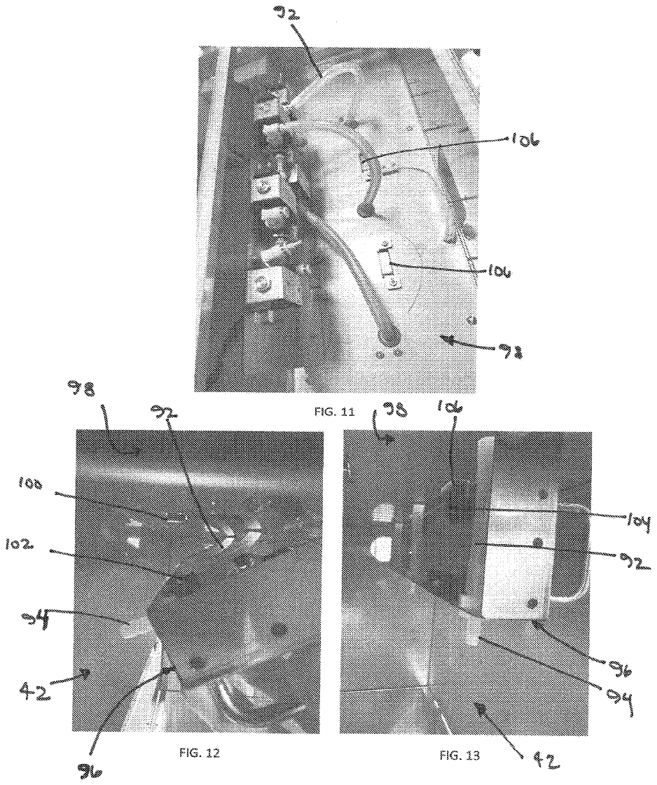

As shown in FIGS. 10-13 a swing arm assembly 90 is provided to controllably position brew dispense lines 92 and the end ports 94 thereof relative to reservoirs contained within the reservoir cavity. The swing arm assembly 90 includes a structure 96 that can be pivoted relative to an internal housing structure 98. The structure 96 is attached to the housing portion 98 by means of a hinge. Other attachments can be used for this purpose. A first set of engagement magnets 100, 102 are provided on the structures 96, 98 to positively retain the structure 96 upwardly. Sensors provided on the assembly 90 are through the magnets 100, 102 provide feedback to the controller of the apparatus 20 to indicate that the assembly 90 is in the upward position. This prevents dispensing through the dispense lines 92. A second set of magnets 104, 106 are used to retain the assembly 90 in the downward or dispensing position. Similarly, sensors are provide to indicate to the controller of the apparatus 20 that the lines 92 and the end ports 94 are in position for dispensing.

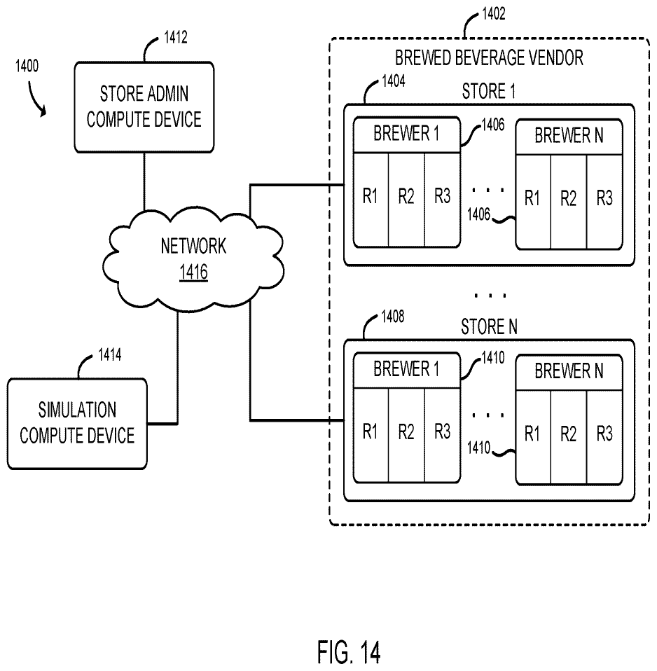

Referring now to FIG. 14, a system 1400 for automatically scheduling brewing and performing schedule optimization simulations, in an illustrative embodiment, is shown. In the example shown, a brewed beverage vendor 1402 has a first store 1404 with a plurality of beverage making and dispensing apparatuses 20, which are embodied as brewers 1406, and a second store 1408 with a plurality of beverage making and dispensing apparatuses 20 that are also embodied as brewers 1410. Although this example shows the brewed beverage vendor 1402 having two stores 1404, 1408, there could be a single store or more than two stores depending on the circumstances. Likewise, even though this example shows two brewers 1406, 1408 in each store 1404, 1408, there could be a single brewer or more than two brewers in each store depending on the circumstances.

In the illustrative embodiment, the brewers 1406, 1410 are communicatively connected with a store admin compute device 1412 and a simulation compute device 1414 via a network 1416. For example, the store admin compute device 1412 could be configured to access information and/or update settings on one or more of the brewers 1406, 1410 remotely via the network 1416. As discussed herein, the simulation compute device 1414 may be configured to perform simulations regarding, among other things, demand for the brewers 1406, 1410 based on recipe, time of day, and/or other factors to determine an optimal brewing schedule to balance beverage waste and customer wait times. For example, the simulation compute device 1404 may include machine learning or other artificial intelligence to determine optimal brewing schedules based on historical brewing data from the brewers 1406, 1410. In some cases, the machine learning or other artificial intelligence could be onboard the brewers 1406, 1410 to automatically determine an optimal brewing schedule based on historical brewing data and update the brewing schedule as brewing demand timing in the data changes.

In the embodiment shown, the brewers 1406, 1410 include reservoirs R1, R2, R3 for holding brewed beverages to be dispensed. The exact time for a brew cycle is dependent on the recipe, but by way of example, could be approximately ninety seconds. In some cases, as explained herein, the brewer 1406, 1410 could be configured to brew different amounts (i.e., beverage volume) based on how much the brewer 1406, 1410 intelligently expects is needed for demand. Typically, there is a maximum volume for one brew cycle. By way of example only, the brewer 1406, 11410 could produce a maximum of 32 ounces in a single brew cycle, but could be configured to produce less than the maximum amount based on expected demand to avoid waste.

The reservoirs R1, R2, R3 could hold three different recipes or beverages with different favor profiles to offer customers different options from which to choose. In some cases, one or more of the reservoirs R1, R2, R3 could have the same recipe or same flavor profile, such for as high demand beverages to provide additional volume that is ready to be dispensed. In high-volume environments, such as a convenience store or grocery store, the brewed beverage vendor 1402 may have multiple brewers in a single location, which allows them to offer a greater variety of recipes, and also allows them to have popular recipes hosted in more than one reservoir. Consider an example in which a brewed beverage vendor has 3 or 4 brewers in a single store, and a popular recipe, such as ‘Regular’ might be served from 2 or 3 of the brewers. Multiple brewers having the same recipe means that there is less chance of a customer having to wait in line to be able to get the recipe they want, but it can also increase waste, since each brewer has its own reservoir holding the brewed beverage. One technical problem solved by embodiments of this disclosure is reducing waste by intelligently determining how much of a brewed beverage to hold in a reservoir based on the time of day, day of week, recipe, etc. So at a very high-demand time of day, the brewer 1406, 1410 might want to hold the maximum amount in the reservoir, while at a time that less of the beverage is sold, the brewer 1406, 1410 might choose to hold much less. In some cases, this could be based on demand on a per reservoir basis; for example, a reservoir holding a beverage with higher demand could hold a higher amount than a beverage in a reservoir with a lower demand. There are competing goals—the brewers 1406, 1410 are configured to balance customers'wait for the beverage to be brewed, or to wait in line behind another customer, with the need to minimize the amount of beverage wasted due to expiration.

The brewers 1406, 1410 are shown with three reservoirs (i.e., R1, R2, R3) for purposes of example only; the brewers 1406, 1410 could have a single reservoir, two reservoirs, or more than three reservoirs depending on the circumstances. Depending on the type of beverage, in some cases, the reservoirs R1, R2, R3 could be insulated and heated (or cooled depending on the beverage type) to maintain the beverage at a consistent temperature. The volume of reservoirs R1, R2, R3 could vary depending on the circumstances, but typically the volume will be larger than the volume that a single customer will dispense so that the customer does not have to wait for a full brew cycle every time they want to dispense.

Once the beverage has been brewed and filled into the reservoir R1, R2 or R3, the beverage has a limited lifespan. The exact lifespan could be specific to the recipe or could be the same predetermined time period for each beverage, such as ninety minutes or some other predetermined time period. Once the beverage in the reservoir has expired (i.e., the lifespan has ended), the reservoir is drained (wasted) and a new batch is brewed.

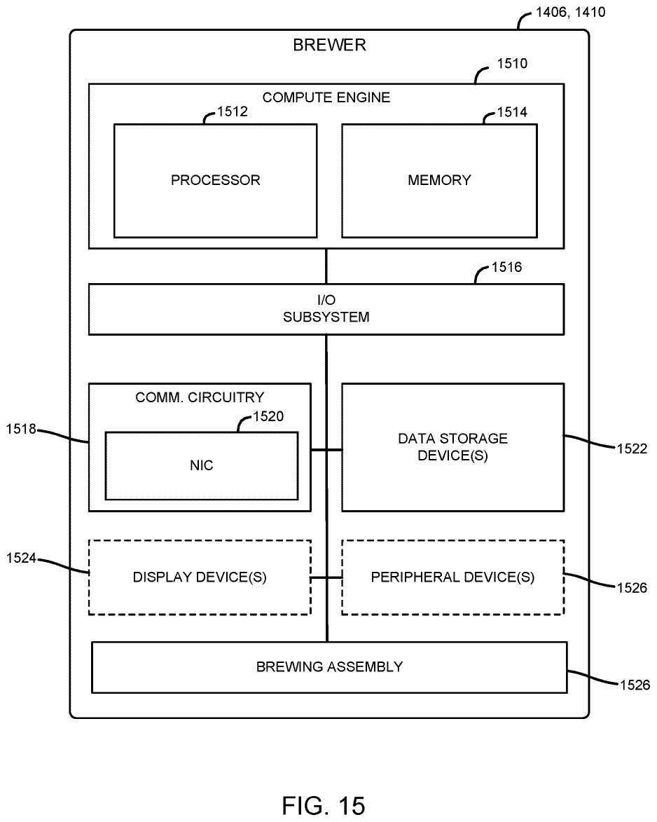

Referring to FIG. 15, the illustrative brewer 1406, 1410 includes a compute engine 1510, an input/output (I/O) subsystem 1516, communication circuitry 1518, and one or more data storage devices 1522. In some embodiments, the brewer 1406, 1410 may include one or more display devices 1524 and/or one or more peripheral devices 1526 (e.g., a mouse, a physical keyboard, etc.). In some embodiments, one or more of the illustrative components may be incorporated in, or otherwise form a portion of, another component. The brewer 1406, 1410 may be embodied as any type of device or collection of devices capable of performing various compute functions described below. In some embodiments, the compute engine 1510 may be embodied as a single device such as an integrated circuit, an embedded system, a field-programmable gate array (FPGA), a system-on-a-chip (SOC), or other integrated system or device. Additionally, in the illustrative embodiment, the compute engine 1510 includes or is embodied as a processor 1512 and a memory 1514. The processor 1512 may be embodied as any type of processor capable of performing the functions described herein. For example, the processor 1512 may be embodied as a single or multi-core processor(s), a microcontroller, or other processor or processing/controlling circuit. In some embodiments, the processor 1512 may be embodied as, include, or be coupled to an FPGA, an application specific integrated circuit (ASIC), reconfigurable hardware or hardware circuitry, or other specialized hardware to facilitate performance of the functions described herein.

In embodiments, the processor 1512 is capable of receiving, e.g., from the memory 1514 or via the I/O subsystem 1516, a set of instructions which when executed by the processor 1512 cause the brewer 1406, 1410 to perform one or more operations described herein. In embodiments, the processor 1512 is further capable of receiving, e.g., from the memory 1514 or via the I/O subsystem 1516, one or more signals from external sources, e.g., from the peripheral devices 1526 or via the communication circuitry 1518 from an external compute device, external source, or external network. As one will appreciate, a signal may contain encoded instructions and/or information. In embodiments, once received, such a signal may first be stored, e.g., in the memory 1514 or in the data storage device(s) 1522, thereby allowing for a time delay in the receipt by the processor 1512 before the processor 1512 operates on a received signal. Likewise, the processor 1512 may generate one or more output signals, which may be transmitted to an external device, e.g., an external memory or an external compute engine via the communication circuitry 1518 or, e.g., to one or more display devices 1524. In some embodiments, a signal may be subjected to a time shift in order to delay the signal. For example, a signal may be stored on one or more storage devices 1522 to allow for a time shift prior to transmitting the signal to an external device. One will appreciate that the form of a particular signal will be determined by the particular encoding a signal is subject to at any point in its transmission (e.g., a signal stored will have a different encoding that a signal in transit, or, e.g., an analog signal will differ in form from a digital version of the signal prior to an analog-to-digital (A/D) conversion).

The main memory 1514 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 1514 may be integrated into the processor 1512. In operation, the main memory 1514 may store various software and data used during operation such as machine learning models, historical Q&A datasets, applications, libraries, and drivers.

The compute engine 1510 is communicatively coupled to other components of the brewer 1406, 1410 via the I/O subsystem 1516, which may be embodied as circuitry and/or components to facilitate input/output operations with the compute engine 1510 (e.g., with the processor 1512 and the main memory 1514) and other components of the brewer 1406, 1410. For example, the I/O subsystem 1516 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 1516 may form a portion of a system-on-a-chip (SoC) and be incorporated, along with one or more of the processor 1512, the main memory 1514, and other components of the brewer 1406, 1410, into the compute engine 1510.

The communication circuitry 1518 may be embodied as any communication circuit, device, or collection thereof, capable of enabling communications over a network between the brewer 1406, 1410 and another device (e.g., store admin compute device 1412, simulation compute device 1414, etc.). The communication circuitry 1518 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 1518 includes a network interface controller (NIC) 1520. The NIC 1520 may be embodied as one or more add-in-boards, daughter cards, network interface cards, controller chips, chipsets, or other devices that may be used by the brewer 1406, 1410 to connect with another compute device (e.g., store admin compute device 1412, simulation compute device 1414, etc.). In some embodiments, the NIC 1520 may be embodied as part of a system-on-a-chip (SoC) that includes one or more processors, or included on a multichip package that also contains one or more processors. In some embodiments, the NIC 1520 may include a local processor (not shown) and/or a local memory (not shown) that are both local to the NIC 1520. Additionally or alternatively, in such embodiments, the local memory of the NIC 1520 may be integrated into one or more components of the brewer 1406, 1410 at the board level, socket level, chip level, and/or other levels.

Each data storage device 1522, may be embodied as any type of device configured for short-term or long-term storage of data such as, for example, memory devices and circuits, memory cards, hard disk drives, solid-state drives, or other data storage device. Each data storage device 1522 may include a system partition that stores data and firmware code for the data storage device 1522 and one or more operating system partitions that store data files and executables for operating systems.

Each display device 1524 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 1524 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the brewer 1406, 1410, store admin compute device 1412, and simulation compute device 1414, are in communication via a network 1416, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

As shown, the brewer 1406, 1410 includes a brewing assembly 1526 configured to create a brewed beverage based on one or more instructions executed by the compute engine 1510. For example, the compute engine 1510 could receive instructions regarding one or more of recipe, temperature, volume, etc. and control the brewing assembly 1526 to create a brewed beverage in accordance with the instructions.

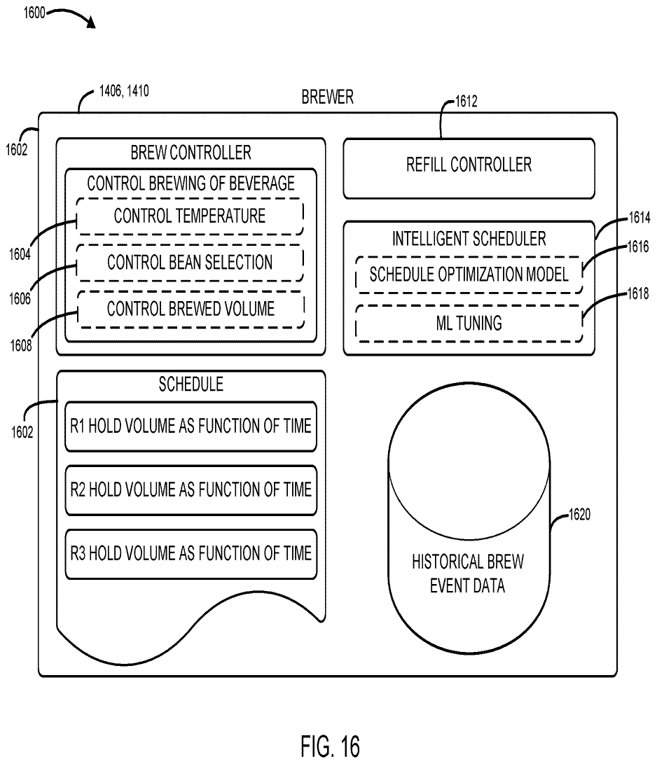

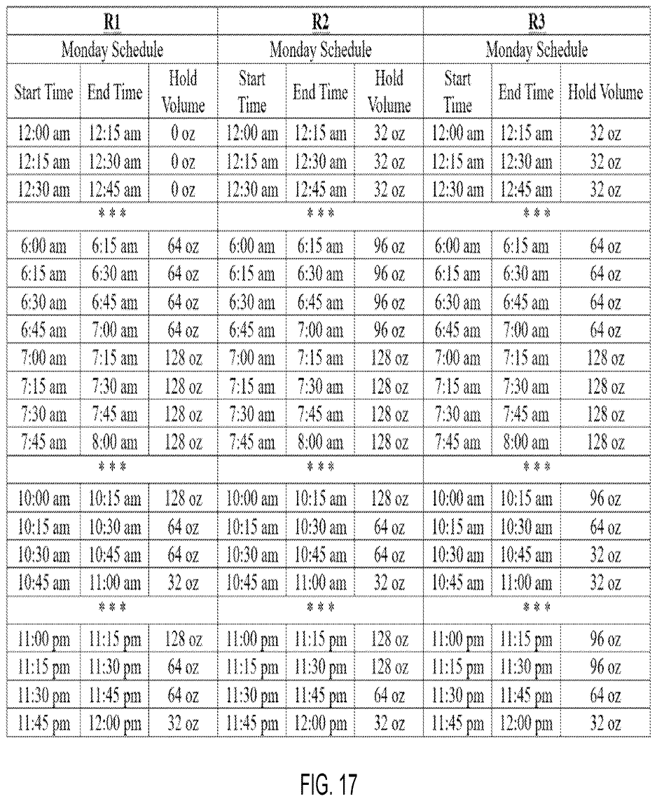

FIG. 16 shows a software environment 1600 of the brewer 1406, 1410 during operation. In the example shown, the environment 1600 includes a brew controller 1602 that is configured to control the brewing assembly 1526. For example, the brew controller 1602 could control a variety of parameters regarding brewing of the beverage, such as the temperature 1604, the bean selection (if the beverage is coffee) 1606, and/or brewed volume 1608. In the embodiment shown, the environment 1600 includes a schedule 1610 that sets forth the hold volume in reservoirs R1, R2, R3 of the brewers 1406, 1410 as a function of time. This provides instructions on how much of the brewed beverage to maintain in each reservoir R1, R2, R3 across all hours of the day. In some embodiments, the schedule 1610 could include a record for intervals of time during the day. By way of example, each hour of the day could be divided into 15 minute intervals (or some other interval) and a corresponding hold volume for that interval for each of the reservoirs R1, R2, R3. The hold volume is the approximate target volume to maintain in the reservoir. In some cases, the schedule could include a start time and end time associated with a hold volume for particular time intervals, such as the example schedule shown in FIG. 17. Depending on the circumstances, the hold volume for each reservoir could be a volume amount between the reservoir's maximum volume and zero. The amount would ideally be higher if that time interval corresponds to a high demand period and lower if that time internal corresponds to a lower demand period.

In the embodiment shown, the brewer 1406, 1410 includes a refill controller 1612 that is configured to control when to initiate brewing a beverage into one or more of the reservoirs R1, R2, R3. The refill controller 1612 includes a variety of events for determining when to initiate brewing of a beverage. In some embodiments, the refill controller 1612 could be configured to maintain an expiration timer for each reservoir R1, R2, R3. As discussed herein, the beverage in the reservoir has an expiration time, which could be based on the recipe for the beverage or a predetermined time period. The refill controller 1612 could keep track of the time until the beverage in each reservoir R1, R2, R3 is expired. In some cases, the refill controller 1612 could include a setting that pauses brewing for a preset amount of time if the beverage in the reservoir is close to expiration until it fully expires and can be dumped. Consider an example in which the pause brewing time is set to 15 minutes, and the beverage in a reservoir is within 15 minutes of expiration. The refill controller 1612 will not initiate brewing any more beverage for that reservoir until the remaining 15 minutes have elapsed. In some cases, the amount of time to pause brewing before the beverage expires could be user-adjustable. Within this pause window of time, the reservoir will not be automatically refilled. In some cases, if the reservoir volume falls below a certain minimum volume threshold during this pause window, that reservoir will automatically be drained and get refilled back to its hold volume. In some cases, the expiration time for a reservoir could be adjusted when a refill occurs. By default, this beverage age timer starts after filling a reservoir from empty and when the timer expires, the beverage is drained. In some cases, however, the age timer could be reset whenever a refill occurs, extending the life of the beverage currently in the reservoir. In some cases, if the hold volume for a reservoir is set to zero, a customer may perform a “brew on demand” which fills the reservoir once with a predetermined volume, such as 24 oz. When the customer attempts to dispense in this mode, in some cases, the brewer could provide a message similar to “Brew started . . . ” and then start a countdown timer on the screen estimating how long the customer will have to wait.

Another trigger for the refill controller 1612 to initiate brewing is if the hold volume set forth in the schedule is less than the actual volume in the reservoir. In some cases, the refill controller 1612 could be configured to wait to brew until a preset amount below the hold volume. For example, the preset amount could be set to the maximum brew volume. Consider an example in which the hold volume is 64 oz, the maximum brew volume is 32 oz, and the actual volume within the reservoir is 52 oz. In this example, the refill controller 1612 could wait to brew until the actual volume within the reservoir is 32 oz, which is the maximum brew volume (32 oz) minus the hold volume (64 oz). In this manner, this provides a “buffer” to wait to refill more efficiently with the largest recipe (32 oz in this example). Consider another example in which the hold volume is set to 24 oz. In this example, the refill controller 1612 refills the reservoir once the volume is less than 24 oz since it needs to be greater than or equal to 24 oz for the tap to become enabled and the customer to dispense. In this scenario, the brewer waits for the dispense to be “idle” before calculating the refill volume. For example, if a customer starts dispensing a 12 oz cup, the brewer will not queue the refill at 23 oz. Instead, the brewer will wait until the dispense ends and the reservoir is at 12 oz. The refill controller 1612 will then initiate refilling with at least a 12 oz brew to get the reservoir back up to the hold volume.

In the embodiment shown, the environment 1600 includes an intelligent scheduler 1614. As shown, the intelligent scheduler 1614 includes a schedule optimization model 1616 and ML tuning 1618. The intelligent scheduler 1614 uses machine learning or artificial intelligence to generate a schedule that optimizes demand based on historical brew event data 1620. The historical brew event data 1620 could be data showing the orders for each of the recipes and the time in which those recipes were ordered. Other meta data associated with the orders could be included, such as the date, weather data, holidays, etc., could be stored in the historical brew event data 1620, and each could potentially impact the schedule.

The intelligent scheduler 1614 is configured to optimize the schedule based on one or more competing goals. For example, the intelligent scheduler 1614 could create a schedule that balances waste of the beverage with wait times of customers. In some cases, the machine learning model(s) used by the intelligent scheduler 1614 to generate the schedule could be tuned through user input. For example, the user could adjust weights for goals of the schedule, such as adjusting the desired balance between beverage waste and wait times. Some stores, for example, may prioritize the lowest customer wait times while others may want to minimize beverage waste.

When the brewer 1406, 1410 and/or recipe for a store location 1404, 1408 is new without any historical brew event data, the intelligent scheduler 1614 generates an initial hold volume schedule. In this situation, the beverage vendor will not usually know much about how demand will vary during the day, how much they will sell of a particular recipe, etc., so they cannot build a truly optimized schedule. However, they will probably know some basic facts, such as how many cups or dollars'worth of coffee they expect to sell in the store per day, and what hours the store is open. In some cases, the intelligent scheduler 1614 could be configured to guide the beverage vendor through a series of questions that will be input into the schedule optimization ML model 1616 to determine an initial hold volume schedule. Additionally, in some embodiments, brewer 1406, 1410 could download historical brew event data from other brewers owned by the beverage vendor with similar expected demographics to supplement the generation of the initial schedule. Generally, the initial hold volume schedule will have to be conservative since the beverage vendor will be essentially guessing at the store demand and would not want to be aggressive on trying to minimize waste.

After sufficient historical brew event data 1620 is generated, the intelligent scheduler 1614 will generate an optimized hold volume schedule using the schedule optimization ML model 1616. In some embodiments, there will need to be a minimum amount of data present before using the intelligent scheduler 1614 makes sense. If the historical brew event data 1620 from the brewer 1406, 1410 does not meet the threshold, the intelligent scheduler 1614 may return an error or otherwise identify there is not yet enough data for meaningful results. In some embodiments, the intelligent scheduler 1614 could attempt to meet one or more of the following criteria: (1) minimize the likelihood of a customer needing to wait for coffee to brew; (2) minimize the likelihood of a customer having to wait in line behind another customer; and (3) minimize the amount of coffee wasted. These criteria are for purposes of example, and other criteria could be relevant depending on the circumstances. As discussed herein, the ML tuning 1618 could be an input to the intelligent scheduler 1614 to identify the goal(s) or relative priorities of optimization. This input could be user-adjustable to set a weight each of the priorities. For example, the user input could be a numerical range (e.g., 1-10) with 1 being the most aggressive and 10 being the least for various goals, such as beverage waste and wait times. Consider an example in which the user selects 3 for beverage waste and 6 for wait times. The intelligent scheduler 1614 will generate an optimized schedule based on these relative priorities.

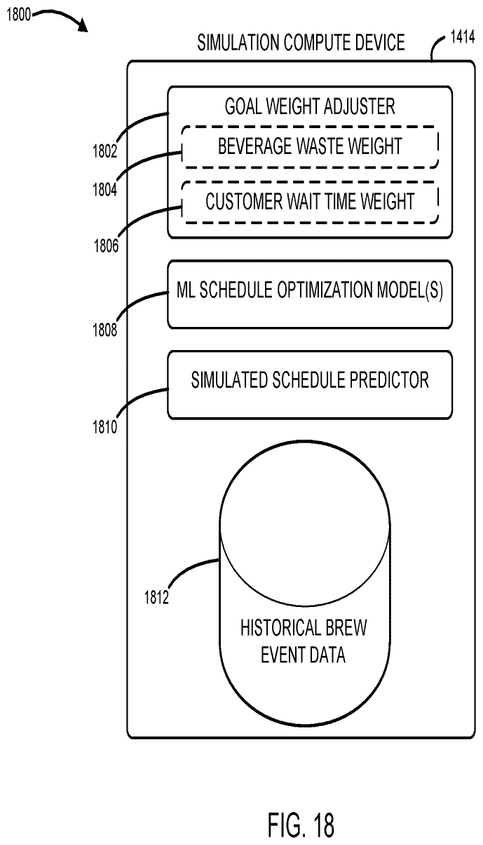

Referring to FIG. 18, shows a software environment 1800 generated by the simulation compute device 1414 during operation. Although simulations are described as being on the simulation compute device 1414 for purposes of example, in some cases, the simulations could be performed on the store admin compute device 1412 and/or brewers 1406, 1410. In the embodiment shown, the environment 1800 includes a goal weight adjuster 1802 in which different goals can be weighted, such as a beverage waste weight 1804 and a customer weight time weight 1806. As shown, the environment 1800 includes a ML schedule optimization model 1808 and a simulated schedule predictor 1810. There is also access to historical brew event data 1812, which could be similar to historical brew event data 1620. For example, historical brew event data 1812 could be downloaded from a brewer of a selected store to run simulations on that brewer to optimize the hold volume schedule for the selected brewer. In some cases, the simulator could be used to compare optimized schedules of ML models 1808. For example, the simulator could ‘play back’ a series of dispense events against a schedule to determine how the algorithm performs based on the criteria of the ‘Optimized Schedule’. In some cases, the simulated schedule predictor 1810 could provide insights to the beverage vendor. For example, the simulated schedule predictor 1810 could generate an optimized schedule based on the vendor's historical data and selected goals from the goal weight adjuster 1802 to determine that the optimized schedule would waste x ounces of coffee and have y instances of customers waiting for coffee during the past month, or something similar. This would give the vendor some real data that tells them how their optimized schedule will work. If the vendor is tweaking the weights on the goal weight adjuster 1802, this would give the vendor an idea of how the waste and customer wait times will play out in the real world.

While the present disclosure describes various exemplary embodiments, the disclosure is not so limited. To the contrary, the disclosure is intended to cover various modifications, uses, adaptations, and equivalent arrangements based on the principles disclosed. Further, this application is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims. The scope of the following claims is to be accorded the broadest interpretation so as to encompass all such modifications and equivalent structures and functions.

1. A brewer comprising:
a brewing assembly to dispense a brewed beverage into one or more reservoirs;
an intelligent scheduler to generate a hold volume schedule based on historical brew event data for the brewer, wherein the hold volume schedule is configured to adjust a volume of the brewed beverage to be maintained in the one or more reservoirs as a function of time; and
a refill controller to initiate brewing of the brewed beverage based on the hold volume schedule.

2. The brewer of claim 1, wherein the intelligent scheduler includes one or more machine learning (ML) models to generate the hold volume schedule.

3. The brewer of claim 1, wherein the one or more ML models are tunable to adjust the hold volume schedule based on one or more goal criteria.

4. The brewer of claim 3, wherein the one or more goal criteria includes beverage waste and customer wait times.

5. The brewer of claim 4, wherein the one or more goal criteria are user-adjustable to change relative priorities between beverage waste and customer wait times.

6. The brewer of claim 1, wherein the hold volume schedule comprises a target volume of brewed beverage in the one or more reservoirs during a plurality of time intervals.

7. The brewer of claim 6, wherein the refill controller is to adjust a volume of brewed beverage in the one or more reservoirs to the target volume in the hold volume schedule.

8. The brewer of claim 1, wherein the intelligent scheduler is further to update the hold volume schedule based on updated historical brew event data for the brewer.

9. A brewer comprising:
a brewing assembly to dispense a brewed beverage into one or more reservoirs;
circuitry configured to:
generate, using one or more machine learning models, a hold volume schedule representing a target volume of brewed beverage to maintain in the one or more reservoirs based on historical brew event data for the brewer; and
initiate brewing of the brewed beverage based on the hold volume schedule such that the brewing assembly fills the one or more reservoirs up to a target hold volume of brewed beverage specified in the hold volume schedule.

10. The brewer of claim 9, wherein to initiate brewing includes circuitry to determine the target hold volume based on a determination of a current time and hold volume corresponding to the current time in the hold volume schedule.

11. The brewer of claim 9, further comprising circuitry to adjust one or more weights of the one or more machine learning models based on one or more goal criteria.

12. The brewer of claim 11, wherein the one or more goal criteria includes beverage waste and customer wait times.

13. The brewer of claim 12, wherein the one or more goal criteria are user-adjustable to change relative priorities between beverage waste and customer wait times.

14. The brewer of claim 9, wherein the hold volume schedule comprises a target volume of brewed beverage in the one or more reservoirs at a plurality of time intervals.

15. The brewer of claim 9, further comprising circuitry to periodically update the hold volume schedule based on updated historical brew event data for the brewer.

16. A compute device comprising:
circuitry configured to:
generate, using one or more machine learning models, a simulated hold volume schedule representing a target volume of brewed beverage to maintain in one or more reservoirs of a brewer based on historical brew event data for the brewer; and
predicting, using one or more machine learning models, one or more of beverage waste and/or customer wait time based on the simulated hold volume schedule.

17. The compute device of claim 16, further comprising circuitry to adjust one or more weights of the one or more machine learning models based on one or more goal criteria.

18. The compute device of claim 17, wherein the one or more goal criteria includes beverage waste and customer wait times.

19. The compute device of claim 18, wherein the one or more goal criteria are user-adjustable to change relative priorities between beverage waste and customer wait times.

20. A beverage producing and dispensing system comprising:
a beverage producing assembly to dispense a produced beverage into one or more reservoirs;
an intelligent scheduler to generate a hold volume schedule based on historical production event data for the beverage producer, wherein the hold volume schedule is configured to adjust a volume of the produced beverage to be maintained in the one or more reservoirs as a function of time; and
a refill controller to initiate production of the beverage based on the hold volume schedule.
